(19) United States
(12) Patent Application Publication
(10) Pub. No.: US 2020/0039506 A1
(43) Pub. Date: Feb. 6, 2020

(54) SYSTEM AND METHOD FOR PROVIDING VISUAL ASSISTANCE DURING AN AUTONOMOUS DRIVING MANEUVER

(71) Applicant: Faraday&Future Inc., Gardena, CA (US)

(72) Inventors: James Joseph WOODBURY, Long Beach, CA (US); Shuo YUAN, Redondo Beach, CA (US)

(21) Appl. No.: 16/053,668

(22) Filed: Aug. 2, 2018

(51) Int. Cl. B60W 30/06; G05D 1/02; B60W 50/14

(52) U.S. Cl. CPC B60W 30/06; G05D 1/0212; B60W 2540/12; B60W 2050/146; B60W 2710/1005; B60W 50/14

(57) ABSTRACT

Systems and methods for providing visual assistance during an autonomous driving maneuver are disclosed. The vehicle includes one or more sensors, one or more processors, and a memory including instructions, which when executed by the one or more processors, cause the one or more processors to perform a method that includes determining available positions of the vehicle based on sensor data received from the one or more sensors, receiving input indicating a selected position of the available positions of the vehicle, providing instructions to autonomously maneuver the vehicle to the selected position based on the sensor data and the selected position, the autonomous maneuver including one or more steps, and providing for display an autonomous driving maneuver user interface including a graphical indicator of a current step of the autonomous maneuver and a graphical indicator of a destination position of the current step.

### FIELD OF ART

The present invention relates generally to a system and method for providing visual assistance during vehicle autonomous driving maneuvers, such as autonomous parking and autonomous unparking. In particular, the embodiments of the present invention relate to methods and apparatus for controlling vehicle autonomous driving maneuvers and displaying visual indicators during a vehicle autonomous driving maneuver.

### BACKGROUND

Current vehicle designs allow a vehicle to autonomously maneuver around small and tight areas that may be difficult for a driver to manually move the vehicle around. For example, some vehicles can autonomously park once a suitable parking space is identified. With autonomous driving maneuvering features such as autonomous parking, the driver's burden is reduced because manually moving the vehicle into parking spots might be a difficult or inconvenient task for many drivers.

However, since autonomous driving features such as autonomous parking are relatively new, many drivers are hesitant to take advantage of these useful features. Some of the hesitations are caused by the driver's fear of the unknown and lack of a sense of control while the maneuver is being automated, for example. Therefore, to improve the user experience of these autonomous features, it is advantageous to increase the driver's confidence by providing the driver more information and improved control while an autonomous driving maneuver is being performed.

The present disclosure addresses this problem and other shortcomings in the automotive field.

### SUMMARY OF THE PRESENT INVENTION

The embodiments of the present invention include systems and methods for realizing an autonomous driving maneuver user interface displayed in an autonomous-maneuvering capable vehicle. In accordance with one embodiment, during an autonomous driving maneuver, the autonomous driving maneuver user interface includes a graphical indicator of a progress or status of the autonomous maneuver (e.g., the parking operation, the unparking operation) and a graphical indicator of a destination vehicle position of a current step of the autonomous maneuver.

In some embodiments, the autonomous driving maneuver user interface provides graphical indicators of the one or more objects sensed by sensors of the vehicle. In some embodiments, prior to performing the autonomous driving maneuver, the autonomous driving maneuver user interface includes graphical indicators of available final vehicle positions based on sensor data.

In some embodiments, the autonomous driving maneuver is one of parking the vehicle or unparking the vehicle. In some embodiments, the autonomous driving maneuver user interface includes affordances to control the autonomous driving maneuver (e.g., the parking operation, the unparking operation) and information associated with the autonomous driving maneuver.

### BRIEF DESCRIPTION OF THE DRAWINGS

The figures are not necessarily to scale, and emphasis is generally placed upon illustrative principles. The figures are to be considered illustrative in all aspects and are not intended to limit the disclosure, the scope of which is defined by the claims.

FIG. 1 illustrates a system block diagram of a vehicle control system according to examples of the disclosure.

FIG. 2A illustrates a vehicle capable of performing autonomous driving maneuvers according to examples of the disclosure.

FIG. 2B illustrates fields of view of LiDAR sensors associated with a vehicle capable of performing autonomous driving maneuvers according to examples of this disclosure.

FIG. 3A illustrates a center information display (CID) and an instrument panel cluster (IPC) according to examples of this disclosure.

FIG. 3B illustrates a more detailed view of an IPC according to examples of this disclosure.

FIGS. 4A-4K illustrate autonomous parking user interfaces according to examples of this disclosure.

FIGS. 5A-5K illustrate autonomous unparking user interfaces according to examples of this disclosure.

FIG. 6 is a flow diagram illustrating a method of providing real-time autonomous driving maneuver control and feedback according to examples of this disclosure.

### DETAILED DESCRIPTION OF EMBODIMENTS

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

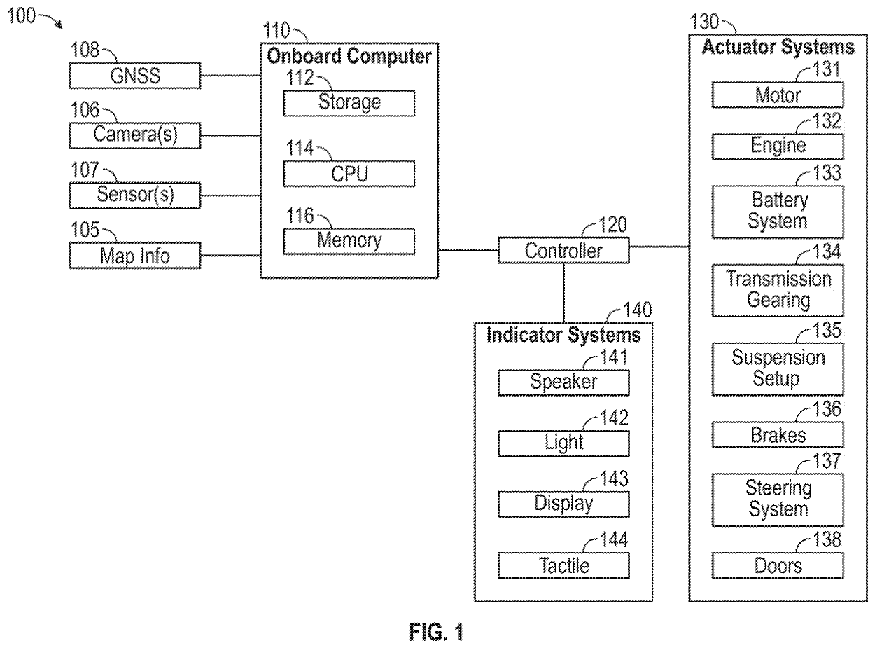

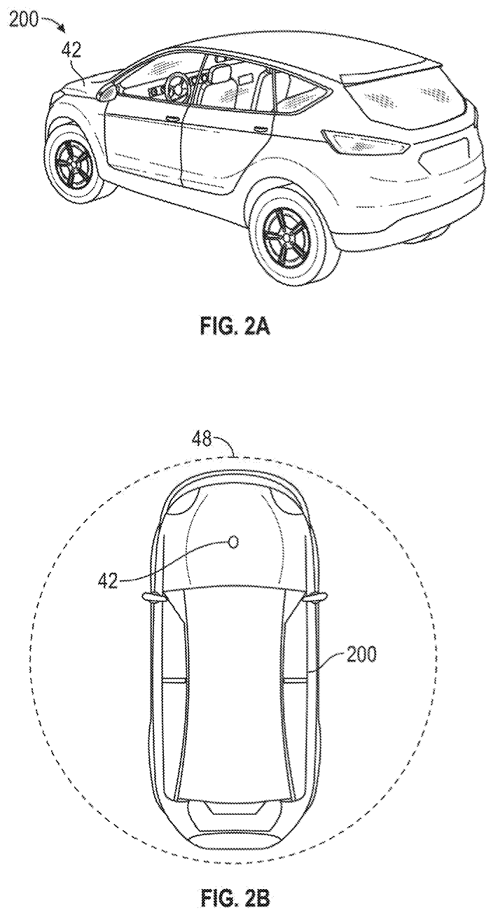

FIG. 1 illustrates an exemplary system block diagram of vehicle control system 100 according to a preferred embodiment of the disclosure. Vehicle control system 100 can perform any of the methods described below with reference to FIGS. 2-6. In some embodiments, system 100 is incorporated into a vehicle, such as a consumer automobile. Other example vehicles that may incorporate the system 100 include, without limitation, airplanes, boats, or industrial automobiles. In some embodiments, vehicle control system 100 includes one or more cameras 106 capable of capturing image data (e.g., image and/or video data) of the vehicle's surroundings, as will be described with reference to FIGS. 2-6. In some embodiments, vehicle control system 100 includes one or more other sensors 107 (e.g., radar, ultrasonic, LiDAR, other range sensors, etc.) capable of detecting various characteristics of the vehicle's surroundings, and a location system, such as a Global Navigation Satellite System (GNSS) receiver 108 capable of determining the location of the vehicle. It should be appreciated that GNSS receiver 108 can be a Global Positioning System (GPS) receiver, BeiDou receiver, Galileo receiver, and/or a GLONASS receiver. In some embodiments, other types of location systems are also used, including cellar, WiFi, or other types of wireless-based and/or satellite-based location systems.

In some embodiments, vehicle control system 100 includes an on-board computer 110 that is operatively coupled to the cameras 106, sensors 107 and GNSS receiver 108, and that is capable of receiving the image data from the cameras and/or outputs from the sensors 107 and the GNSS receiver 108. In some embodiments, the on-board computer 110 is capable of receiving parking lot map information 105 (e.g., via a wireless and/or internet connection at the vehicle). It is understood by ones of ordinary skill in the art that map data can be matched to location data in map-matching functions. In accordance with one embodiment of the invention, the on-board computer 110 is capable of performing autonomous parking in a parking lot using camera(s) 106 and GNSS receiver 108, as described in this disclosure.

In accordance with the preferred embodiment, the on-board computer 110 includes storage 112, memory 116, and a processor 114. Processor 114 can perform any of the methods described with reference to FIGS. 2-6. Additionally, storage 112 and/or memory 116 can store data and instructions for performing any of the methods described with reference to FIGS. 2-6. Storage 112 and/or memory 116 can be any non-transitory computer readable storage medium, such as a solid-state drive or a hard disk drive, among other possibilities. In some embodiments, the vehicle control system 100 includes a controller 120 capable of controlling one or more aspects of vehicle operation, such as controlling motion of the vehicle during autonomous driving maneuver in a parking lot.

In some embodiments, the vehicle control system 100 is connected to (e.g., via controller 120) one or more actuator systems 130 in the vehicle and one or more indicator systems 140 in the vehicle. The one or more actuator systems 130 can include, but are not limited to, a motor 131, engine 132, battery system 133, transmission gearing 134, suspension setup 135, brakes 136, steering system 137 and door system 138. In some embodiments, the vehicle control system 100 controls, via controller 120, one or more of these actuator systems 130 during vehicle operation; for example, to open or close one or more of the doors of the vehicle using the door actuator system 138, to control the vehicle during autonomous driving or parking operations using the motor 131 or engine 132, battery system 133, transmission gearing 134, suspension setup 135, brakes 136 and/or steering system 137, etc. In some embodiments, the one or more indicator systems 140 include, but are not limited to, one or more speakers 141 in the vehicle (e.g., as part of an entertainment system in the vehicle), one or more lights 142 in the vehicle, one or more displays 143 in the vehicle (e.g., as part of a control or entertainment system in the vehicle, such as a heads-up display (HUD), a center information display (CID), or an instrument panel cluster (IPC)) and one or more tactile actuators 144 in the vehicle (e.g., as part of a steering wheel or seat in the vehicle). In some embodiments, the vehicle control system 100 controls, via controller 120, one or more of these indicator systems 140 to provide indications to a driver of the vehicle of one or more aspects of the automated parking procedure of this disclosure, such as successful identification of an empty parking space, or the general progress of the vehicle in autonomously parking itself In some embodiments, during an autonomous driving maneuver (e.g., autonomous parking or autonomous unparking), one or more of these displays presents an autonomous driving maneuver user interface including images, information, and/or selectable affordances related to the autonomous driving maneuver, as will be described in more detail below with reference to FIGS. 2-6.

FIG. 2A illustrates a vehicle 200 capable of performing autonomous driving maneuvers according to a preferred embodiment of the disclosure. The vehicle 200 optionally includes one or more sensors 42 (e.g., ultrasonic sensors, Radar, LiDAR, proximity sensors). In some embodiments, the sensor 42 has a field of view projected around the vehicle 200, thereby enabling the sensor 42 to detect objects and available parking spaces or openings proximate to the vehicle within the sensing range of the sensor. Sensor 42 is optionally retained by an electronics housing (not shown) capable of positing the sensor 42 above the vehicle 200. In some embodiments, the electronics housing is operatively coupled to a controller of the vehicle 200. In some embodiments, the controller transmits a signal to raise the electronics housing into a sensing position while the vehicle 200 performs an autonomous driving maneuver or scans an environment prior to performing the autonomous driving maneuver. In some embodiments, the controller transmits a signal to lower the electronics housing into a storage position when the vehicle or the sensor 42 is not in use. Although sensor 42 is illustrated as having a particular location on the vehicle and is described as being retained by a retractable housing, in some embodiments, other sensor positions and/or housings are possible. For example, rather than including one retractable sensor, the vehicle optionally includes a plurality of sensors at different locations on the vehicle to achieve a similar field of view as field of view 48.

FIG. 2B illustrates a field of view of the sensor 42 corresponding to the configurations of the sensor 42 of FIG. 2A. For clarity, the fields of view of other sensors which may be on the vehicle are not shown. As shown in the figure, the field of view 48 can project at a further distance from the vehicle than a dimension of the vehicle, allowing the vehicle to sense beyond its immediate surroundings (e.g., searching for an empty parking spot, searching for openings to exit a parking spot). Although the field of view 48 is illustrated as radially surrounding the sensor 42, it is understood that the field of view 48 can be any pattern suitable for sensing a vehicle's environment. Additionally, field of view 48 may be substantially larger than the vehicle 200. In some embodiments, field of view 48 may include an entire parking lot.

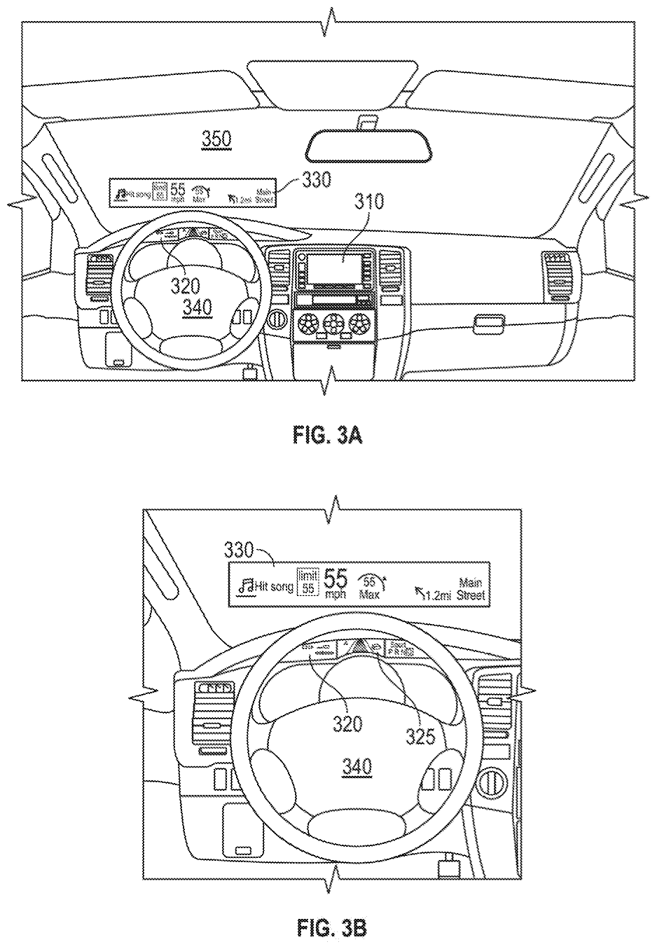

FIG. 3A illustrates a center information display (CID) 310 and an exemplary instrument panel cluster (IPC) 320 according to a preferred embodiment of this disclosure. In some embodiments, the CID 310 is a touch display located at the center of the vehicle interior. In some embodiments, the CID 310 is located at a location of the vehicle interior that can be easily accessed (e.g., reached, touched, viewed) by the driver and/or passengers. In some examples, the CID 310 optionally displays information associated with the vehicle (e.g., vehicle state, vehicle settings) or running applications (e.g., a music application, a navigation application, a communication application, autonomous parking user interface, autonomous unparking interface, etc.).

In some embodiments, the IPC 320 is located between a steering column 340 of the vehicle and a windshield 350 of the vehicle. The windshield 350 of the vehicle can include a heads up display (HUD) 330. In some examples, the IPC 320 optionally displays information associated with the vehicle (e.g., current gear, road conditions, surrounding objects, environment temperature, drive mode, current time) or associated with a running application or process (e.g., currently playing media content). In some examples, the IPC 320 and/or the HUD 330 optionally displays specific information that is the most relevant to the driver, so the driver can view the most relevant information without having to turn to the CID 310. In some embodiments, information associated with the CID 310 and the IPC 320 is displayed on a combined device. For example, the combined device is optionally one large touch display screen.

Although the CID 310 is shown as a touch screen at the center of the vehicle interior, it is understood that the CID 310 can be any device or plurality of devices capable of receiving inputs from a user and displaying information associated with the vehicle or applications running on the devices. Although the components in FIG. 3A are described as shown in the figure and their functions are described as being performed with the described devices, it is understood that any combinations of the components described in FIG. 3A or different devices can achieve substantially similar functions without departing from the scope of the disclosure.

FIG. 3B illustrates a detailed view of IPC 320 according to a preferred embodiment of this disclosure. The IPC 320 includes a vehicle environment information user interface 325. In some embodiments, the vehicle environmental information user interface 325 displays information associated with the vehicle's environment. In some examples, the information user interface 325 optionally displays current road conditions. In some examples, the information user interface 325 optionally visually displays nearby objects detected by vehicle sensors (e.g., ultrasonic sensors, Radar, LiDAR, proximity sensors) to alert the driver that one or more objects are very close to the vehicle. In some examples, the nearby objects are optionally displayed while the vehicle is moving at a low speed (e.g., while parking, while moving out of a parking space, while reversing, while moving slowly in traffic).

Although the information user interface 325 is shown as being displayed near center of the IPC 320, it is understood that the information user interface 325 can be located or displayed in a different location without departing from the scope of the disclosure.

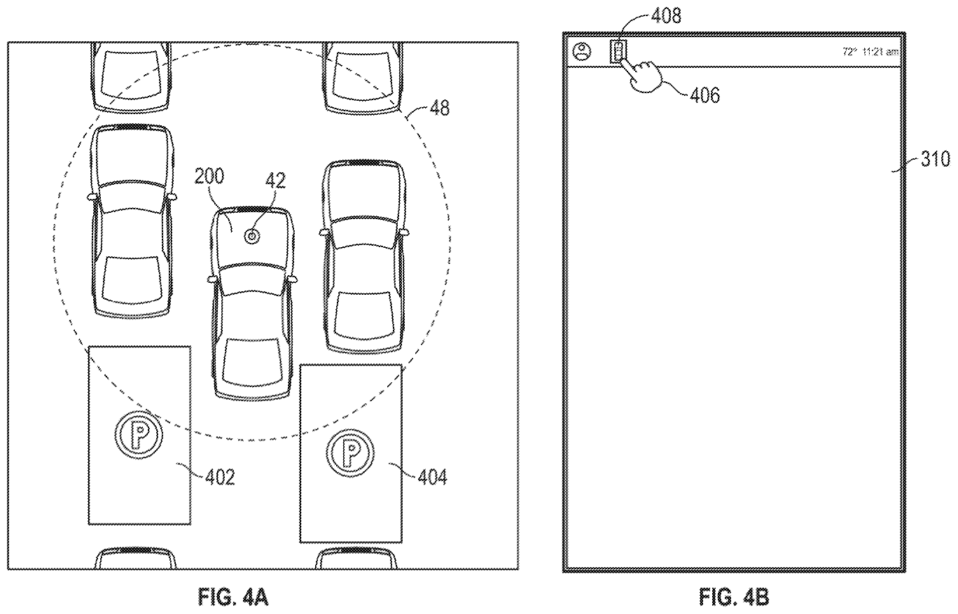

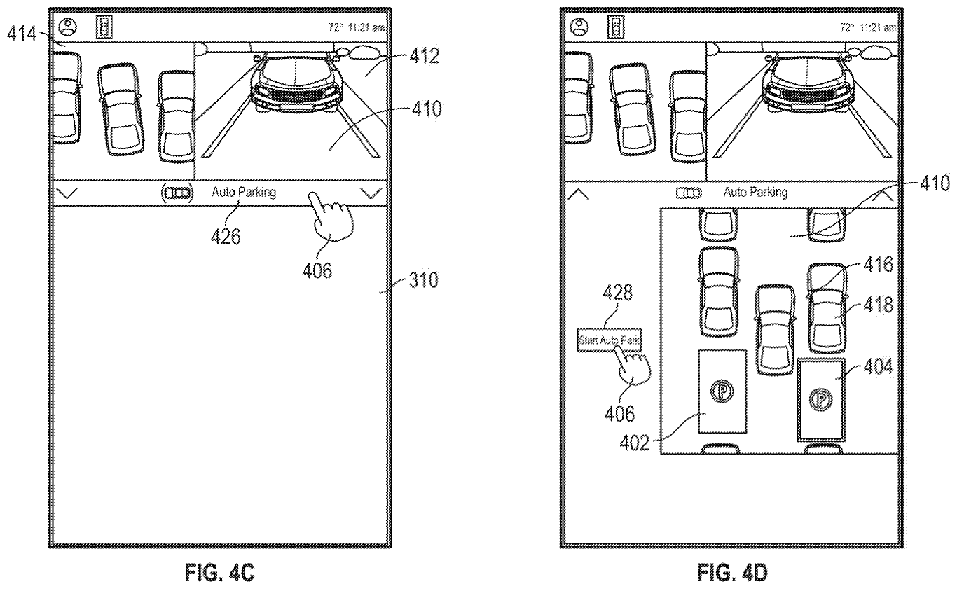

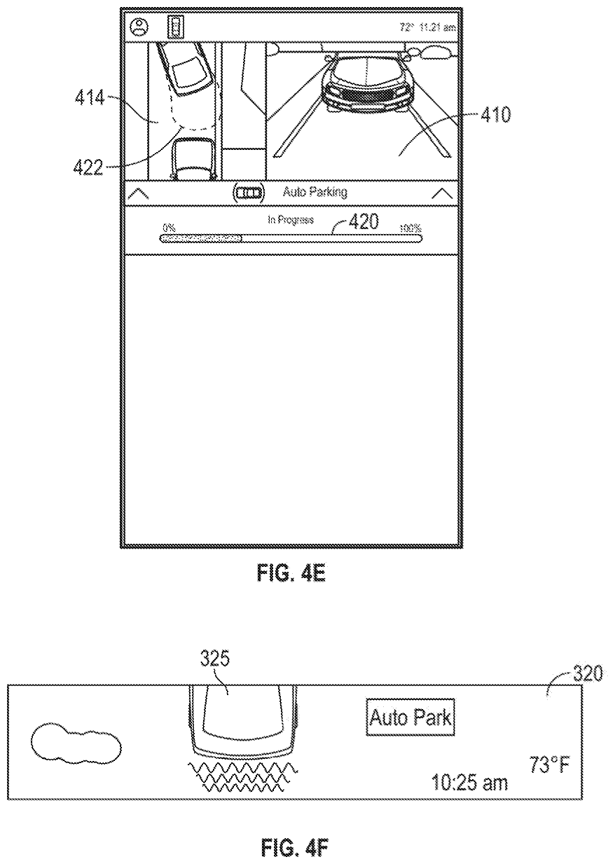

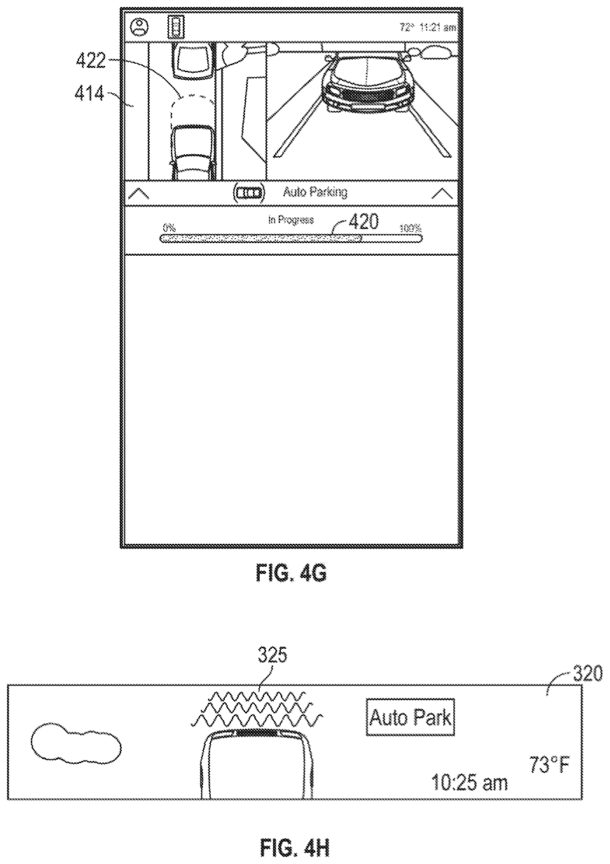

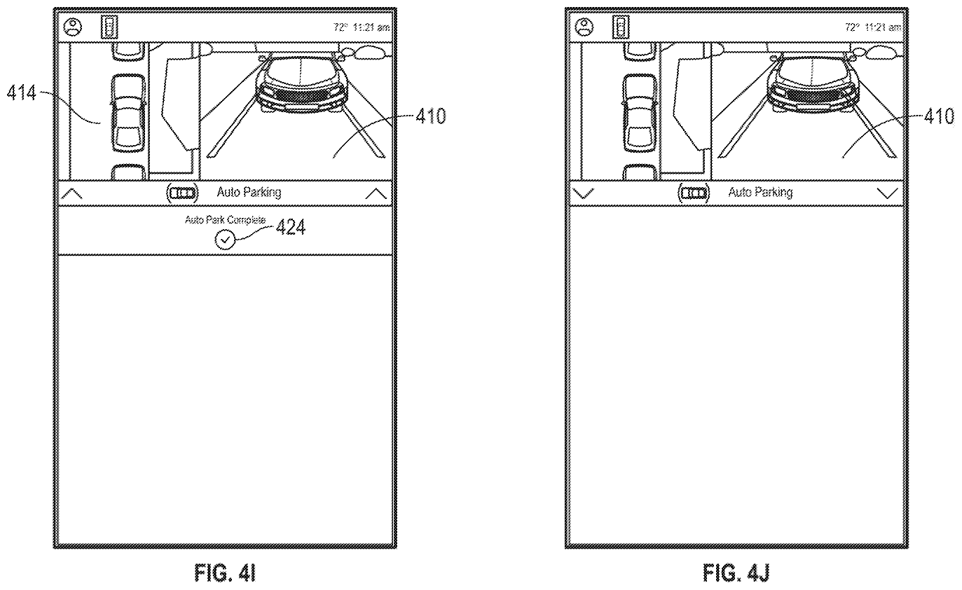

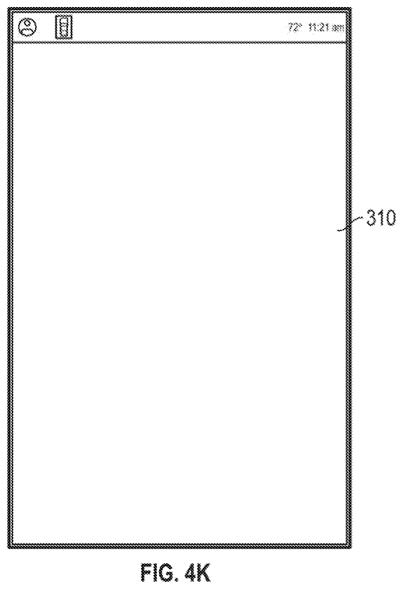

FIGS. 4A-4K illustrate autonomous parking user interfaces according to a preferred embodiment of this disclosure. FIG. 4A is a top-down view of an exemplary vehicle 200 in an exemplary parking lot having empty parking spots 402 and 404. In some embodiments, the vehicle is able to park in the empty parking spots 402 and 404 by performing an autonomous driving maneuver. In other words, the empty parking spots are available final vehicle positions of the autonomous driving maneuver. The parking spots are illustrated merely for exemplary purposes. It is understood that the final vehicle positions of an autonomous driving maneuver can be any space or opening suitable for the vehicle.

Sensor 42 is optionally raised above the vehicle 200. In some embodiments, the sensor 42 has a field of view projected around the vehicle 200, thereby enabling the sensor 42 to detect objects and available parking spaces or openings proximate to the vehicle within the sensing range of the sensor. Sensor 42 is optionally retained by an electronics housing (not shown) capable of positing the sensor 42 above the vehicle 200. In some embodiments, the electronics housing is operatively coupled to a controller of the vehicle 200. In some embodiments, the controller transmits a signal to raise the electronics housing into a sensing position while the vehicle 200 performs an autonomous driving maneuver or scans an environment prior to performing the autonomous driving maneuver. In some embodiments, the controller transmits a signal to lower the electronics housing into a storage position when the vehicle or the sensor 42 is not in use. Although sensor 42 is illustrated as having a particular location on the vehicle and is described as being retained by a retractable housing, in some embodiments, other sensor positions and/or housings are possible. For example, rather than including one retractable sensor, the vehicle optionally includes a plurality of sensors at different locations on the vehicle to achieve a similar field of view as field of view 48.

FIG. 4B illustrates an exemplary user interface displayed on the CID 310. The user interface optionally includes an affordance 408 selectable to initiate an autonomous parking maneuver. In some embodiments, the CID 310 displays one or more user interfaces associated with an application (e.g., a music application, a navigation application, etc.) running on an onboard computer of the vehicle or one or more user interfaces associated with an operation performed by the onboard computer of the vehicle. As shown in FIG. 4B, touch object 406 (e.g., a finger, a stylus, etc.), as symbolically represented by a hand symbol, selects affordance 408 (e.g., an autonomous driving maneuver GUI object). In response to the selection of the affordance 408, an autonomous driving maneuver user interface 410 is launched and displayed on the CID 310. Alternatively or additionally, the autonomous driving maneuver user interface 410 is launched in response to a driving gear (e.g., reverse, drive) being shifted by the driver or in response to another user input for commencing the autonomous parking maneuver (e.g., a voice command).

FIG. 4C illustrates an exemplary autonomous driving maneuver user interface 410 displayed on the CID 310. In some embodiments, the real-time proximity image 412 is a backup camera image or ultrasonic images from front or rear bumpers. The top-down view 414 is optionally generated using one or more vehicle sensors (e.g., LiDAR, ultrasonic, proximity sensors, camera, Radar, etc.).

In some embodiments, the autonomous driving maneuver user interface 410 occupies a portion (e.g., a top portion) of the display of the CID 310. In some embodiments, user interfaces associated with concurrently running applications (e.g., running prior to launching the autonomous driving maneuver user interface 410) are displayed on portions of the display of the CID 310 not occupied by the autonomous driving maneuver user interface 410. As shown in FIG. 4C, the touch object 406 selects an affordance 426 associated with a desired autonomous driving maneuver (e.g., “Auto Parking”) to be performed by the vehicle.

In some embodiments, the CID 310 ceases to display the autonomous driving maneuver user interface 410 after a threshold amount of time (e.g., 10 seconds) of inactivity, when an area outside the autonomous driving maneuver user interface 410 on the CID 310 is selected, or when an opposite driving gear is selected (e.g., reverse to forward, forward to reverse). After the CID 310 ceases to display the autonomous driving maneuver user interface 410, the CID 310 can display the one or more user interfaces that were displayed prior to displaying the autonomous driving maneuver user interface 410 or one or more user interfaces that were selected outside the autonomous driving maneuver user interface 410.

In response to the selection of the affordance 426 associated with the desired autonomous driving maneuver (e.g., “Auto Parking”), the autonomous driving maneuver user interface 410 optionally expands and occupies the previously-unoccupied display area on the CID 310, as shown in FIG. 4D. In some embodiments, the expanded portions of the autonomous driving maneuver user interface 410 include a vehicle environment image 416 (e.g., a still image or a video illustrating one or more objects proximate to the vehicle). Additionally, in some embodiments, in response to the selection, a command is sent to a controller of the vehicle to raise one or more sensors or an electronics housing including the sensors. The command moves the sensors or the sensor housing into a sensing position from a storage position. For example, the sensing position is optionally above the vehicle, providing sensors an unobstructed field of view, and the storage position is optionally under the hood of the vehicle, preventing the sensors from blocking the windshield while the sensors are not in use.

In some embodiments, the vehicle environment image 416 includes a top-down representation of an environment (e.g., a parking lot) generated with information sensed by the vehicle sensors (e.g., sensor 42). The sensed information optionally includes information about objects within a sensing range (e.g., field of view 48) of the vehicle sensors. The vehicle environment image 416 includes graphical indicators of one or more sensed objects (e.g., sensed cars 418) and graphical indicators of available final vehicle positions (e.g., empty parking spots 402 and 404) of the autonomous vehicle driving maneuver.

In the figure, a desired final available vehicle position is selected (e.g., empty parking spot 404) and the selection is indicated by a highlight around the selected final vehicle position. In some embodiments, the user is able to select the final vehicle position to be maneuvered into with the autonomous driving maneuver (e.g., the user can select which parking space they want the vehicle to autonomously park into). As shown in the figure, once a desired available final vehicle position is selected, the touch object 406 selects an affordance 428 (e.g., “Start Auto Park”) to perform the autonomous vehicle driving maneuver for positioning the vehicle in the selected available final vehicle position (e.g., empty parking spot 404). In some embodiments, once the vehicle begins to perform the autonomous driving maneuver, the CID 310 ceases to display the vehicle environment image 416. The CID 310 optionally displays, in place of the vehicle environment image 416, a user interface that had previously been displayed prior to the display of the autonomous maneuver user interface.

Once the autonomous vehicle driving maneuver begins, a progress bar 420 is displayed in the autonomous driving maneuver user interface 410, as shown in FIG. 4E. In some embodiments, the progress bar 420 is a graphical indicator of the progress (e.g., 33%) of the parking operation (i.e., the autonomous driving maneuver) being performed by the vehicle.

In some embodiments, the autonomous driving maneuver includes one or more steps, such as alternated backwards and forwards movements, to position the vehicle in the parking space. While a current step is being performed by the vehicle (e.g., reverse movement), the top-down view 414 of the autonomous driving maneuver user interface 410 optionally includes a graphical indicator of a destination vehicle position of the current step of the autonomous driving maneuver. For example, in a zoomed view, dashed lines 422 optionally indicates where the vehicle intends to stop for the current step (e.g., vehicle will back into the dashed lines 422). The zoomed view is optionally focused on the direction of vehicle travel. For example, if the current step is a reverse movement, the zoomed view optionally focuses on the vehicle's rear bumper and the dashed lines 422 optionally indicate where the vehicle will reverse to. In some embodiments, the dashed lines 422 are generated from proximity estimation by software installed in the vehicle computer or controller. In some embodiments, the one or more steps are indicated with markers (not shown) on the progress bar 420. Displaying the indication of the destination vehicle position of the current step of the autonomous driving maneuver allows the vehicle to communicate to the user where the vehicle intends to stop, which, in some situations, eases user anxiety that the vehicle could collide with a proximate object (e.g., the other vehicle parked behind the parking space) while performing the autonomous driving maneuver.

In some embodiments, while the autonomous driving maneuver is being performed, the driver is able to override or cease the autonomous driving maneuver. For example, the driver can cease the autonomous driving maneuver by depressing the brake pedal. In some embodiments, the autonomous driving user interface 410 includes a written indication that the user can cease the autonomous driving maneuver by depressing the brake pedal (e.g., one or more of text or an image, such as text that says “press brake pedal to stop”). When the user depresses the brake pedal during the autonomous driving maneuver, the vehicle controller (e.g., controller 120) optionally detects the depression of the brake pedal. In response to the depression of the brake pedal, the vehicle ceases to perform the autonomous driving maneuver, and the display displays a graphical indicator that the autonomous driving maneuver has ceased (not shown).

In some embodiments, during the autonomous driving maneuver, a second display (e.g., IPC 320) displays a graphical indicator of an object (e.g., a car near the selected final vehicle destination) proximate to the vehicle in a direction of the current step of the autonomous maneuver. FIG. 4F illustrates an image displayed by the IPC during an autonomous driving maneuver according to a preferred embodiment of the disclosure. For example, while performing a current step (e.g., reversing), vehicle environment information user interface 325 displays a graphical indicator of an object to the rear and left directions of the rear bumper, detected by vehicle sensors (e.g., radar, ultrasonic, LIDAR, other range sensors, etc.).

FIG. 4G illustrates the autonomous driving user interface 410 as the autonomous vehicle driving maneuver continues with a next step of the maneuver. Progress bar 420 is updated on the autonomous driving maneuver user interface 410, as shown in FIG. 4G. In some embodiments, the progress bar 420 indicates the progress (e.g., 66%) of the parking operation (i.e., the autonomous driving maneuver). In some embodiments, the one or more steps of the autonomous driving maneuver are indicated with markers (not shown) on the progress bar 420.

As shown in FIG. 4G, the current step is a forward movement and the top-down view 414 of the autonomous driving maneuver user interface 410 displays a graphical indicator of a destination vehicle position of the current step of the autonomous driving maneuver. For example, in a zoomed view, dashed lines 422 optionally indicates where the vehicle intends to stop for the current step (e.g., vehicle will move forward into the dashed lines 422). In some embodiments, the dashed lines 422 are generated from proximity estimation by software installed in the vehicle computer (e.g., on-board computer 110) or controller (e.g., controller 120).

FIG. 4H illustrates an image displayed by a second display during an autonomous driving maneuver according to a preferred embodiment of the disclosure. As shown in the figure, the second display (e.g., IPC 320) displays a graphical indicator of an object (e.g., a car near the selected final vehicle destination) proximate to the vehicle in the direction of the current step of the autonomous maneuver. For example, while performing a current step (e.g., moving forward), vehicle environmental information user interface 325 displays a graphical indicator of an object to the front and center directions of the front bumper, detected by vehicle sensors (e.g., radar, ultrasonic, LIDAR, other range sensors, etc.).

After all of the steps of the autonomous driving maneuver are completed, as shown in FIG. 4I, the display ceases displaying the progress bar 420 and temporarily displays (e.g., for 2 seconds or some other amount of time) a graphical indicator 424 that the autonomous driving maneuver is complete. The top-down view 414 of the autonomous driving maneuver user interface 410 displays a graphical indicator of the environment around the vehicle in the final vehicle position. For example, a top-down representation of the vehicle in its final parking position and adjacent vehicles are displayed. After a threshold amount of time (e.g., 2 seconds or some other amount of time), as shown in FIG. 4J, the display ceases display of the indication 424.

In FIG. 4K, the display of the CID 310 ceases to display the autonomous driving maneuver user interface 410 after a threshold amount of time (e.g., 10 seconds) after the vehicle ceases to perform or completes the autonomous driving maneuver. In some embodiments, after ceasing to display the autonomous driving maneuver user interface 410, the CID 310 displays one or more other user interfaces of applications running on an onboard computer of the vehicle.

Although specific behaviors, in response to an override, cancellation, or completion of the autonomous driving maneuver, of the autonomous driving maneuver user interface 410 are described, it is understood that the responses of the autonomous driving maneuver user interface 410 are not limited to the described behaviors. The autonomous driving maneuver user interface 410 can exhibit different combinations of the behaviors or substantially similar behaviors without departing from the scope of the disclosure.

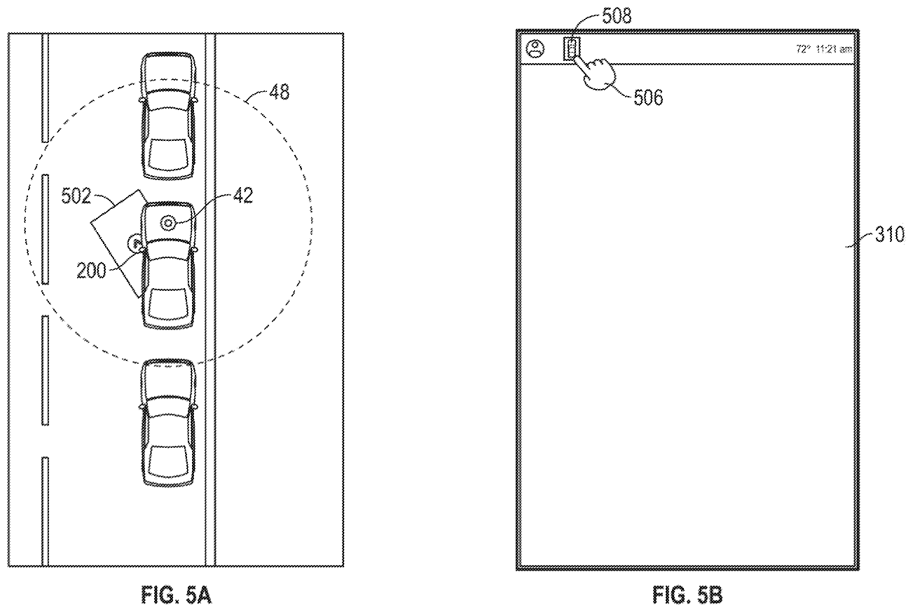

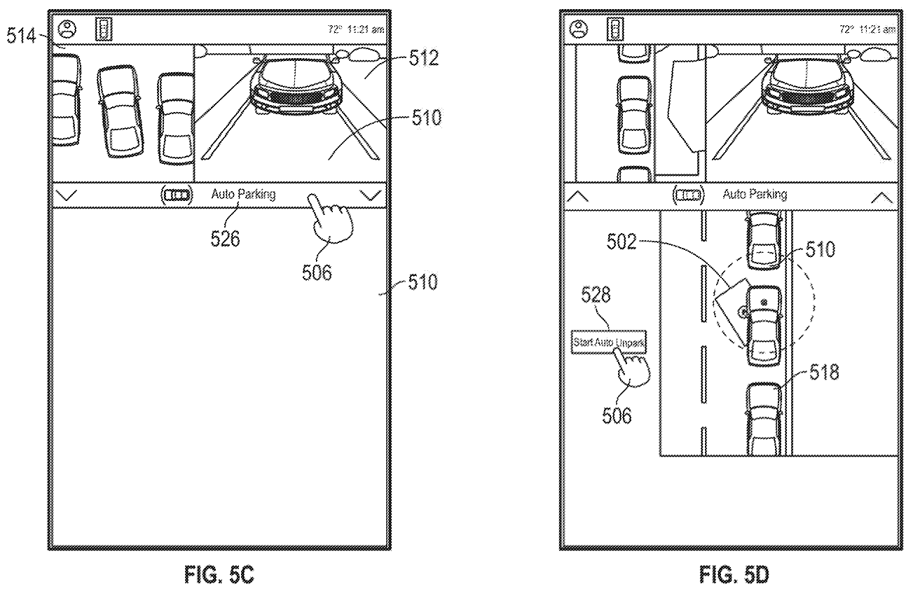

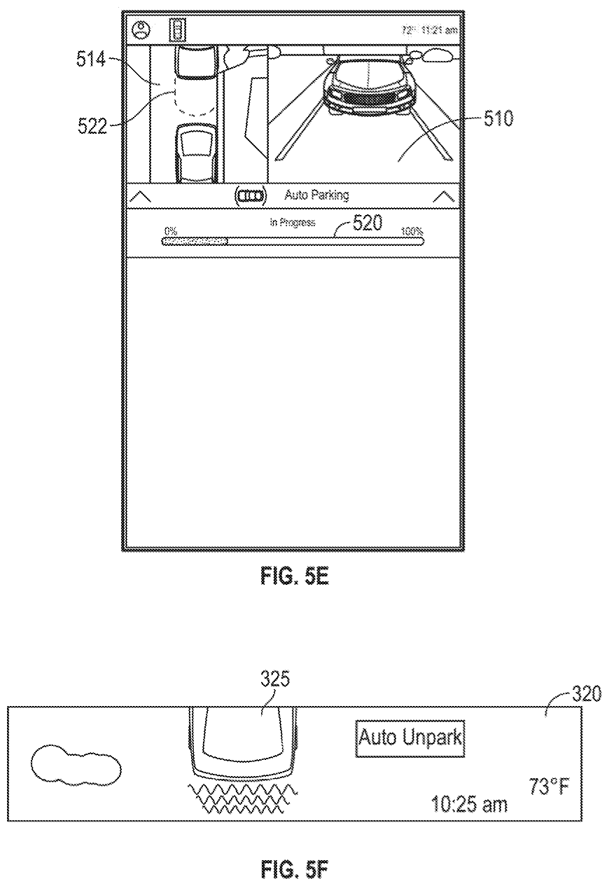

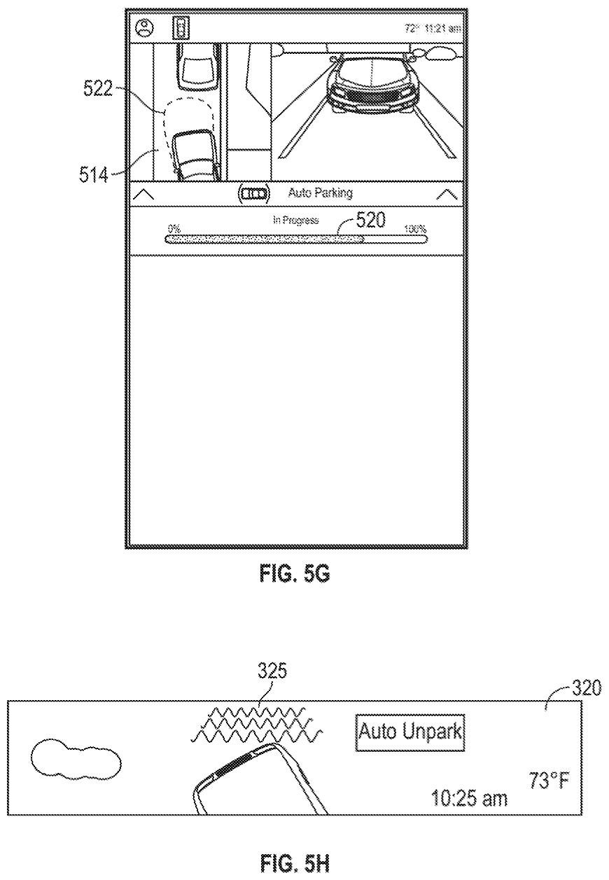

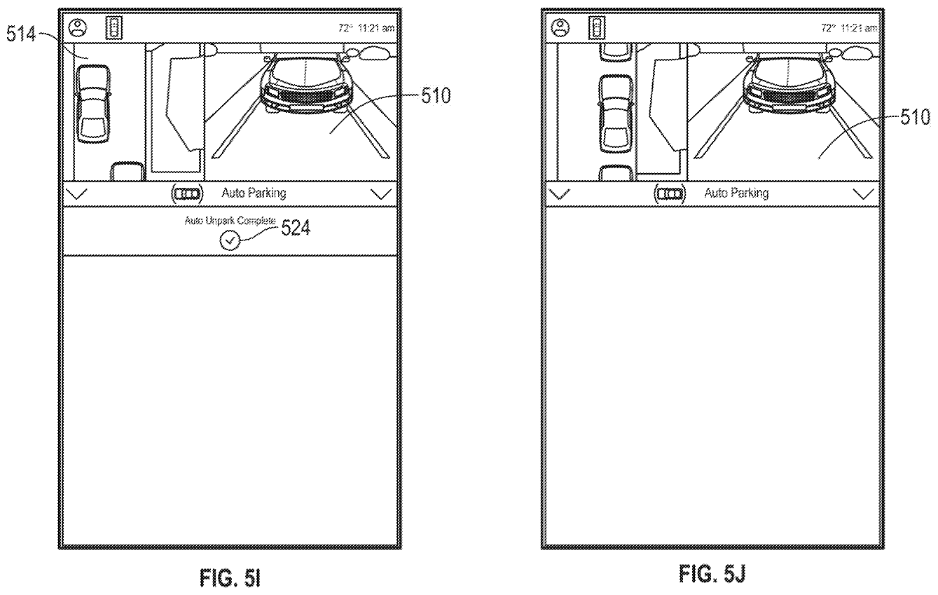

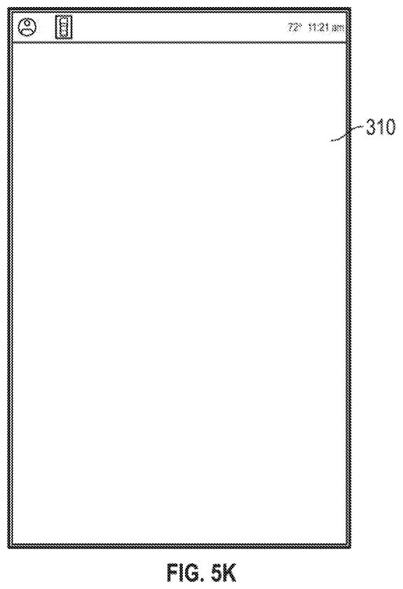

FIGS. 5A-5K illustrate exemplary autonomous unparking user interfaces according to a preferred embodiment of this disclosure. FIG. 5A is a top-down view of an exemplary vehicle 200 in an exemplary parking lot with an available final unparked vehicle position 502. In some embodiments, the vehicle is able to unpark from the parking spot by performing an autonomous driving maneuver to the available final unparked vehicle position 502. The available final unparked vehicle position 502 is illustrated merely for exemplary purposes. It is understood that the final vehicle positions of an autonomous driving maneuver can be any space or opening suitable for the vehicle to exit out of a parking spot. Although one available final unparked vehicle position is shown in the description, it is understood that more than one available final unparked vehicle positions exist for any vehicle at any parking spot.

Although the term “unpark” is used to describe examples of the vehicle 200 maneuvering out of a parking spot, it is understood that the term is not limited to the descriptions describing the examples. It is understood that the term “unpark” can be any maneuver out of a vehicle's currently stationary position.

Sensor 42 is optionally raised above the vehicle 200. In some embodiments, the sensor 42 has a field of view projected around the vehicle 200, thereby enabling the sensor 42 to detect objects and available parking spaces or openings proximate to the vehicle within the sensing range of the sensor. Sensor 42 is optionally retained by an electronics housing (not shown) capable of positing the sensor 42 above the vehicle 200. In some embodiments, the electronics housing is operatively coupled to a controller of the vehicle 200. In some embodiments, the controller transmits a signal to raise the electronics housing into a sensing position while the vehicle 200 performs an autonomous driving maneuver or scans an environment prior to performing the autonomous driving maneuver. In some embodiments, the controller transmits a signal to lower the electronics housing into a storage position when the vehicle or the sensor 42 is not in use. Although sensor 42 is illustrated as having a particular location on the vehicle and is described as being retained by a retractable housing, in some embodiments, other sensor positions and/or housings are possible. For example, rather than including one retractable sensor, the vehicle optionally includes a plurality of sensors at different locations on the vehicle to achieve a similar field of view as field of view 48.

FIG. 5B illustrates an exemplary user interface displayed on the CID 310. The user interface optionally includes an affordance 508 selectable to initiate an autonomous parking maneuver. In some embodiments, the CID 310 displays one or more user interfaces associated with an application (e.g., a music application, a navigation application, etc.) running on an onboard computer of the vehicle or one or more user interfaces associated with an operation performed by the onboard computer of the vehicle. As shown in FIG. 5B, touch object 506 (e.g., a finger, a stylus, etc.), as symbolically represented by a hand symbol, selects affordance 408 (e.g., an autonomous driving maneuver GUI object). In response to the selection of the affordance 508, an autonomous driving maneuver user interface 510 is launched and displayed on the CID 310. Alternatively or additionally, the autonomous driving maneuver user interface 510 is launched in response to a driving gear (e.g., reverse, drive) being shifted by the driver or in response to another user input for commencing the autonomous parking maneuver (e.g., a voice command).

FIG. 5C illustrates an exemplary autonomous driving maneuver user interface 510 displayed on the CID 310. In some embodiments, the real-time proximity image 512 is a backup camera image or ultrasonic images from front or rear bumpers. The top-down view 514 is optionally generated using one or more vehicle sensors (e.g., LiDAR, ultrasonic, proximity sensors, camera, Radar, etc.).

In some embodiments, the autonomous driving maneuver user interface 510 occupies a portion (e.g., a top portion) of the display of the CID 310. In some embodiments, user interfaces associated with concurrently running applications (e.g., running prior to launching the autonomous driving maneuver user interface 510) are displayed on portions of the display of the CID 310 not occupied by the autonomous driving maneuver user interface 510. As shown in FIG. 5C, the touch object 506 selects an affordance 526 associated with a desired autonomous driving maneuver (e.g., “Auto Parking”) to be performed by the vehicle. Although the affordance 526 is shown with the text “Auto Parking,” it is understood that, in some embodiments, the text changes to “Auto Unparking” when autonomous unparking is being performed.

In some embodiments, the CID 310 ceases to display the autonomous driving maneuver user interface 510 after a threshold amount of time (e.g., 10 seconds) of inactivity, when an area outside the autonomous driving maneuver user interface 510 on the CID 310 is selected, or when an opposite driving gear is selected (e.g., forward to reverse, reverse to forward). After the CID 310 ceases to display the autonomous driving maneuver user interface 510, the CID 310 can display the one or more user interfaces that were displayed prior to displaying the autonomous driving maneuver user interface 510 or the one or more user interfaces that were selected from an area outside the autonomous driving maneuver user interface 510.

In response to the selection of the affordance 526 associated with the desired autonomous driving maneuver (e.g., “Auto Parking”), the autonomous driving maneuver user interface 510 optionally expands and occupies the previously-unoccupied display area on the CID 310, as shown in FIG. 5D. In some embodiments, the expanded portions of the autonomous driving maneuver user interface 510 include a vehicle environment image 516 (e.g., a still image or a video illustrating one or more objects proximate to the vehicle). Additionally, in some embodiments, in response to the selection, a command is sent to a controller of the vehicle to raise one or more sensors or an electronics housing including the sensors. The command moves the sensors or the sensor housing into a sensing position from a storage position. For example, the sensing position is optionally above the vehicle, providing sensors an unobstructed field of view, and the storage position is optionally under the hood of the vehicle, preventing the sensors from blocking the windshield while the sensors are not in use.

In some embodiments, the vehicle environment image 516 includes a top-down representation of an environment (e.g., a parking lot) generated with information sensed by the vehicle sensors (e.g., sensor 42). The sensed information optionally includes information about objects within a sensing range (e.g., field of view 48) of the vehicle sensors. The vehicle environment image 516 includes graphical indicators of one or more sensed objects (e.g., sensed cars 518) and graphical indicators of available final vehicle positions (e.g., available final vehicle position 502) of the autonomous vehicle driving maneuver.

In the figure, a desired final available vehicle position is selected (e.g., available final vehicle position 502) and the selection is indicated by a highlight around the selected final vehicle position. In some embodiments, the user is able to select the final vehicle position to be maneuvered into with the autonomous driving maneuver (e.g., the user can select the final vehicle position after the vehicle finishes unparking). As shown in the figure, once a desired available final vehicle position is selected, the touch object 506 selects an affordance 528 (e.g., “Start Auto Unpark”) to perform the autonomous vehicle driving maneuver for positioning the vehicle in the selected available final vehicle position (e.g., available final vehicle position 502). In some embodiments, once the vehicle begins to perform the autonomous driving maneuver, the CID 310 ceases to display the vehicle environment image 516. The CID 310 optionally displays, in place of the vehicle environment image 516, a user interface that had previously been displayed prior to the display of the autonomous maneuver user interface. Although one available final unparked vehicle position is shown in the examples, it is understood that more than one available final unparked vehicle positions exist and can be available for selection for any vehicle at any parking spot.

Once the autonomous vehicle driving maneuver begins, a progress bar 520 is displayed in the autonomous driving maneuver user interface 510, as shown in FIG. 5E. In some embodiments, the progress bar 520 is a graphical indicator of the current progress (e.g., 33%) of the unparking operation (i.e., the autonomous driving maneuver) being performed by the vehicle.

In some embodiments, the autonomous driving maneuver includes one or more steps, such as alternated backwards and forwards movements, to position the vehicle out of the parking space. While a current step is being performed by the vehicle (e.g., reverse movement), the top-down view 514 of the autonomous driving maneuver user interface 510 optionally includes a graphical indicator of a destination vehicle position of the current step of the autonomous driving maneuver. For example, in a zoomed view, dashed lines 522 optionally indicates where the vehicle intends to stop for the current step (e.g., vehicle will back into the dashed lines 522). The zoomed view is optionally focused on the direction of vehicle travel. For example, if the current step is a reverse movement, the zoomed view optionally focuses on the vehicle's rear bumper and the dashed lines 522 optionally indicate where the vehicle will reverse to. In some embodiments, the dashed lines 522 are generated from proximity estimation by software installed in the vehicle computer or controller. In some embodiments, the one or more steps are indicated with markers (not shown) on the progress bar 520. Displaying the indication of the destination vehicle position of the current step of the autonomous driving maneuver allows the vehicle to communicate to the user where the vehicle intends to stop, which, in some situations, eases user anxiety that the vehicle could collide with a proximate object (e.g., the other vehicle parked behind the parking space) while performing the autonomous driving maneuver.

In some embodiments, while the autonomous driving maneuver is being performed, the driver is able to override or cease the autonomous driving maneuver. For example, the driver can cease the autonomous driving maneuver by depressing the brake pedal. In some embodiments, the autonomous driving user interface 510 includes a written indication that the user can cease the autonomous driving maneuver by depressing the brake pedal (e.g., one or more of text or an image, such as text that says “press brake pedal to stop”). When the user depresses the brake pedal during the autonomous driving maneuver, the vehicle controller (e.g., controller 120) optionally detects the depression of the brake pedal. In response to the depression of the brake pedal, the vehicle ceases to perform the autonomous driving maneuver, and the display displays a graphical indicator that the autonomous driving maneuver has ceased (not shown).

In some embodiments, during the autonomous driving maneuver, a second display (e.g., IPC 320) displays a graphical indicator of an object (e.g., a car near the selected final vehicle destination) proximate to the vehicle in a direction of the current step of the autonomous maneuver. FIG. 5F illustrates an image displayed by the IPC during an autonomous driving maneuver according to a preferred embodiment of the disclosure. For example, while performing a current step (e.g., reversing), vehicle environment information user interface 325 displays a graphical indicator of an object to the rear and left directions of the rear bumper, detected by vehicle sensors (e.g., radar, ultrasonic, LIDAR, other range sensors, etc.).

FIG. 5G illustrates the autonomous driving user interface 510 as the autonomous vehicle driving maneuver continues with a next step of the maneuver. Progress bar 520 is updated on the autonomous driving maneuver user interface 510, as shown in FIG. 5G. In some embodiments, the progress bar 520 indicates the progress (e.g., 66%) of the unparking operation (i.e., the autonomous driving maneuver). In some embodiments, the one or more steps of the autonomous driving maneuver are indicated with markers (not shown) on the progress bar 520.

As shown in FIG. 5G, the current step is a forward movement and the top-down view 514 of the autonomous driving maneuver user interface 510 displays a graphical indicator of a destination vehicle position of the current step of the autonomous driving maneuver. For example, in a zoomed view, dashed lines 522 optionally indicates where the vehicle intends to stop for the current step (e.g., vehicle will forward into the dashed lines 522). In some embodiments, the dashed lines 522 are generated from proximity estimation by software installed in the vehicle computer (e.g., on-board computer 110) or controller (e.g., controller 120).

FIG. 5H illustrates an image displayed by a second display during an autonomous driving maneuver according to a preferred embodiment of the disclosure. As shown in the figure, the second display (e.g., IPC 320) displays a graphical indicator of an object (e.g., a car near the selected final vehicle destination) proximate to the vehicle in the direction of the current step of the autonomous maneuver. For example, while performing a current step (e.g., moving forward), vehicle environmental information user interface 325 displays a graphical indicator of an object to the front and right directions of the front bumper, detected by vehicle sensors (e.g., radar, ultrasonic, LIDAR, other range sensors, etc.).

After all of the steps of the autonomous driving maneuver are completed, as shown in FIG. 5I, the display ceases displaying the progress bar 520 and temporarily displays (e.g., for 2 seconds or some other amount of time) a graphical indicator 524 that the autonomous driving maneuver is complete. The top-down view 514 of the autonomous driving maneuver user interface 510 displays a graphical indicator of the environment around the vehicle in the final vehicle position. For example, a top-down representation of the vehicle in its final unparking position and adjacent vehicles are displayed. After a threshold amount of time (e.g., 2 seconds or some other amount of time), as shown in FIG. 5J, the display ceases display of the indication 524.

In FIG. 5K, the display of the CID 310 ceases to display the autonomous driving maneuver user interface 510 after a threshold amount of time (e.g., 10 seconds) after the vehicle ceases to perform or completes the autonomous driving maneuver. In some embodiments, after ceasing to display the autonomous driving maneuver user interface 510, the CID 310 displays one or more other user interfaces of applications running on an onboard computer of the vehicle.

Although specific behaviors, in response to an override, cancellation, or completion of the autonomous driving maneuver, of the autonomous driving maneuver user interface 510 are described, it is understood that the responses of the autonomous driving maneuver user interface 510 are not limited to the described behaviors. The autonomous driving maneuver user interface 510 can exhibit different combinations of the behaviors or substantially similar behaviors without departing from the scope of the disclosure.

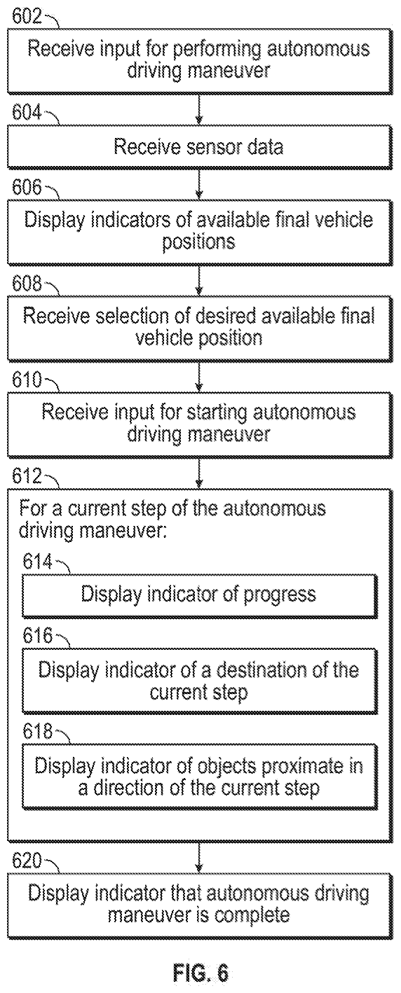

FIG. 6 is a flow diagram illustrating a method of providing real-time autonomous driving maneuver control and feedback according to a preferred embodiment of this disclosure. In some embodiments, the vehicle 200 receives (602) input for performing autonomous driving maneuver, such as in FIGS. 4B and 5B (e.g., an input corresponding to a selection of an affordance associated with auto parking or auto unparking is received).

In some embodiments, in response to receiving the input for performing the autonomous driving maneuver, the vehicle 200 receives (604) sensor data associated with the vehicle's environment, such as in FIGS. 4C and 5C (e.g., the vehicle receive sensor data generate using one or more vehicle sensors (e.g., LiDAR, ultrasonic, proximity sensors, camera, Radar, etc.)).

In some embodiments, in response to receiving the sensor data associated with the vehicle's environment, the vehicle 200 displays (606) one or more graphical indicators of available final vehicle positions, such as in FIGS. 4D and 5D (e.g., available final vehicle positions (e.g., available parking spots, available final unparking position) are displayed).

In some embodiments, the vehicle receives (608) selection of a desired available final vehicle position, such as in FIGS. 4D and 5D (e.g., desired final vehicle position (e.g., parking spot 404, final unparking position 502) is selected). In some embodiments, the vehicle receives (610) input for starting the autonomous driving maneuver, such as in FIGS. 4D and 5D (e.g., the vehicle receives selection of an affordance (e.g., “Start Auto Park” affordance 428, “Start Auto Unpark” affordance 528).

In some examples, the autonomous driving maneuver optionally includes one or more steps, such as alternated backwards and forwards movements to position the vehicle in or out the parking space. In some embodiments, for a current step of the autonomous driving maneuver (612), the vehicle 200 displays (614) indication of progress, such as in FIGS. 4E, 4G, 5E, and 5G (e.g., progress bar 420 on the CID 310, progress bar 520 on the CID 310). In some embodiments, for a current step of the autonomous driving maneuver (612), the vehicle 200 displays (616) indication of a destination of the current step, such as in FIGS. 4E, 4G, 5E, and 5G (e.g., dashed lines 422 on the CID 310, dashed lines 522 on the CID 310). In some embodiments, for a current step of the autonomous driving maneuver (612), the vehicle 200 displays (618) graphical indicator of objects proximate in a direction of the current step, such as in FIGS. 4F, 4H, 5F, and 5H (e.g., vehicle environmental information user interface 325 on the instrument panel cluster (IPC) 320). In some embodiments, one or more of steps 614 to 618 are performed for each of the steps of the autonomous driving maneuver until the vehicle 200 maneuvers into the desired available final vehicle position.

In some embodiments, the vehicle 200 displays (620) a graphical indicator that autonomous driving maneuver is complete, such as in FIGS. 4I and 5I (e.g., “Auto Park Complete” indication 424, “Auto Unpark Complete” indication 524).

Although the flow diagram includes the described steps, it is understood that any combination of steps or substantially similar steps can exist for the disclosed autonomous driving maneuvers without departing from the scope of the disclosure.

According to the above, some examples of the disclosed invention are directed to a vehicle comprising: one or more sensors; one or more processors; and a memory including instructions, which when executed by the one or more processors, cause the one or more processors to perform a method comprising: determining available positions of the vehicle based on sensor data received from the one or more sensors; receiving input indicating a selected position of the available positions of the vehicle; providing instructions to autonomously maneuver the vehicle to the selected position based on the sensor data and the selected position, the autonomous maneuver including one or more steps; and providing for display an autonomous driving maneuver user interface including a graphical indicator of a current step of the autonomous maneuver and a graphical indicator of a destination position of the current step.

Additionally or alternatively to one or more of the examples described above, in some examples, the autonomous maneuver is one of parking the vehicle or unparking the vehicle.

Additionally or alternatively to one or more of the examples described above, in some examples, the method further comprises: receiving input to perform the autonomous maneuver, the input comprising one or more of shifting a driving gear of the vehicle and selection of an affordance associated with the autonomous maneuver, wherein the instructions to autonomously maneuver the vehicle are provided in response to the input to perform the autonomous driving maneuver.

Additionally or alternatively to one or more of the examples described above, in some examples, the method further comprises: ceasing the provided display of the autonomous driving maneuver user interface after a threshold amount of time after the vehicle ceases to perform the autonomous maneuver.

Additionally or alternatively to one or more of the examples described above, in some examples, the vehicle further comprises: an electronics housing that retains the one or more sensors, wherein the method further comprises: while determining the available positions of the vehicle or performing the autonomous maneuver, providing instructions to raise the electronics housing into a sensing position, and while the vehicle is not in use, providing instructions to lower the electronics housing into a storage position.

Additionally or alternatively to one or more of the examples described above, in some examples, the sensor data includes data associated with one or more objects within a sensing range of the vehicle, and the autonomous driving maneuver user interface further includes graphical indicators of at least one of the one or more sensed objects.

Additionally or alternatively to one or more of the examples described above, in some examples, the current step includes one of forward maneuver or reverse maneuver, while performing the forward maneuver, the graphical indicators of the at least one of the one or more sensed objects include graphical indicators of front objects of the one or more sensed objects, and while performing the reverse maneuver, the graphical indicators of the at least one of the one or more sensed objects include graphical indicators of rear objects of the one or more sensed objects.

Additionally or alternatively to one or more of the examples described above, in some examples, the vehicle further comprises: a first display and a second display, wherein the autonomous driving maneuver user interface is displayed on the first display; the method further comprises providing for display, on the second display, a graphical indicator of proximate objects of the one or more sensed objects in a direction of the current step of the autonomous maneuver.

Additionally or alternatively to one or more of the examples described above, in some examples, prior to receiving the input indicating the selected position of the available positions of the vehicle, the autonomous driving maneuver user interface further includes graphical indicators of the available positions of the vehicle, and the input indicating the selected position of the available positions of the vehicle includes a selection of an affordance associated with one of the graphical indicators of the available positions of the vehicle.

Additionally or alternatively to one or more of the examples described above, in some examples, the vehicle further comprises: a brake pedal, wherein the method further comprises: while performing the autonomous driving maneuver, receiving input indicating a depression of the brake pedal, and in response to the input indicating the depression of the brake pedal: providing instructions to cease the autonomous driving maneuver, and providing for display a graphical indicator indicating that the autonomous driving maneuver has ceased.

Additionally or alternatively to one or more of the examples described above, in some examples, the method further comprises, when the autonomous driving maneuver is complete, providing for display a graphical indicator indicating that autonomous maneuver is complete.

According to the above, some examples of the disclosed invention are directed to a non-transitory computer-readable medium including instructions, which when executed by one or more processors, cause the one or more processors to perform a method comprising: determining available positions of a vehicle based on sensor data received from one or more sensors; receiving input indicating a selected position of the available positions of the vehicle; providing instructions to autonomously maneuver the vehicle to the selected position based on the sensor data and the selected position, the autonomous maneuver including one or more steps; and providing for display an autonomous driving maneuver user interface including a graphical indicator of a current step of the autonomous maneuver and a graphical indicator of a destination position of the current step.

Additionally or alternatively to one or more of the examples described above, in some examples, the autonomous maneuver is one of parking the vehicle or unparking the vehicle.

Additionally or alternatively to one or more of the examples described above, in some examples, the sensor data includes data associated with one or more objects within a sensing range of the vehicle, and the autonomous driving maneuver user interface further includes graphical indicators of at least one of the one or more sensed objects.

Additionally or alternatively to one or more of the examples described above, in some examples, prior to receiving the input indicating the selected position of the available positions of the vehicle, the autonomous driving maneuver user interface further includes graphical indicators of the available positions of the vehicle, and the input indicating the selected position of the available positions of the vehicle includes a selection of an affordance associated with one of the graphical indicators of the available positions of the vehicle.

According to the above, some examples of the disclosed invention are directed to a method comprising: determining available positions of a vehicle based on sensor data received from one or more sensors of the vehicle; receiving input indicating a selected position of the available positions of the vehicle; providing instructions to autonomously maneuver the vehicle to the selected position based on the sensor data and the selected position, the autonomous maneuver including one or more steps; and providing for display an autonomous driving maneuver user interface including a graphical indicator of a current step of the autonomous maneuver and a graphical indicator of a destination position of the current step.

Additionally or alternatively to one or more of the examples described above, in some examples, the autonomous maneuver is one of parking the vehicle or unparking the vehicle.

Additionally or alternatively to one or more of the examples described above, in some examples, the sensor data includes data associated with one or more objects within a sensing range of the vehicle, and the autonomous driving maneuver user interface further includes graphical indicators of at least one of the one or more sensed objects.

Additionally or alternatively to one or more of the examples described above, in some examples, prior to receiving the input indicating the selected position of the available positions of the vehicle, the autonomous driving maneuver user interface further includes graphical indicators of the available positions of the vehicle, and the input indicating the selected position of the available positions of the vehicle includes a selection of an affordance associated with one of the graphical indicators of the available positions of the vehicle.

According to the above, some examples of the disclosed invention are directed to a vehicle comprising: means for determining available positions of the vehicle based on sensor data received from one or more sensors of the vehicle; means for receiving input indicating a selected position of the available positions of the vehicle; means for providing instructions to autonomously maneuver the vehicle to the selected position based on the sensor data and the selected position, the autonomous maneuver including one or more steps; and means for providing for display an autonomous driving maneuver user interface including a graphical indicator of a current step of the autonomous maneuver and a graphical indicator of a destination position of the current step.

The use of sections is not meant to limit the disclosure; each section can apply to any aspect, embodiment, or feature of the disclosure.

Where devices are described as having, including, or comprising specific components, or where processes are described as having, including or comprising specific process steps, it is contemplated that devices of the disclosure also consist essentially of, or consist of, the recited components, and that the processes of the disclosure also consist essentially of, or consist of, the recited process steps.

The use of the terms “include,” “includes,” “including,” “have,” “has,” or “having” should be generally understood as open-ended and non-limiting unless specifically stated otherwise. The use of the singular herein includes the plural (and vice versa) unless specifically stated otherwise. Moreover, the singular forms “a,” “an,” and “the” include plural forms unless the context clearly dictates otherwise.

The term “about” before a quantitative value includes the specific quantitative value itself, unless specifically stated otherwise. As used herein, the term “about” refers to a ±10% variation from the quantitative value.

It should be understood that the order of steps or order for performing certain actions is immaterial so long as the disclosure remains operable. Moreover, two or more steps or actions may be conducted simultaneously.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

1. A vehicle comprising:
one or more sensors;
one or more processors; and
a memory including instructions, which when executed by the one or more processors, cause the one or more processors to perform a method comprising:
determining available positions of the vehicle based on sensor data received from the one or more sensors;
receiving input indicating a selected position of the available positions of the vehicle;
providing instructions to autonomously maneuver the vehicle to the selected position based on the sensor data and the selected position, the autonomous maneuver including one or more steps; and
providing for display an autonomous driving maneuver user interface including a graphical indicator of a current step of the autonomous maneuver and a graphical indicator of a destination position of the current step.

2. The vehicle of claim 1, wherein the autonomous maneuver is one of parking the vehicle or unparking the vehicle.

3. The vehicle of claim 1, wherein the method further comprises:
receiving input to perform the autonomous maneuver, the input comprising one or more of shifting a driving gear of the vehicle and selection of an affordance associated with the autonomous maneuver, wherein the instructions to autonomously maneuver the vehicle are provided in response to the input to perform the autonomous driving maneuver.

4. The vehicle of claim 1, wherein the method further comprises:
ceasing the provided display of the autonomous driving maneuver user interface after a threshold amount of time after the vehicle ceases to perform the autonomous maneuver.

5. The vehicle of claim 1, further comprising:
an electronics housing that retains the one or more sensors, wherein the method further comprises:
while determining the available positions of the vehicle or performing the autonomous maneuver, providing instructions to raise the electronics housing into a sensing position, and
while the vehicle is not in use, providing instructions to lower the electronics housing into a storage position.

6. The vehicle of claim 1, wherein:
the sensor data includes data associated with one or more objects within a sensing range of the vehicle, and
the autonomous driving maneuver user interface further includes graphical indicators of at least one of the one or more sensed objects.

7. The vehicle of claim 6, wherein:
the current step includes one of forward maneuver or reverse maneuver,
while performing the forward maneuver, the graphical indicators of the at least one of the one or more sensed objects include graphical indicators of front objects of the one or more sensed objects, and
while performing the reverse maneuver, the graphical indicators of the at least one of the one or more sensed objects include graphical indicators of rear objects of the one or more sensed objects.

8. The vehicle of claim 6, further comprising:
a first display and a second display, wherein the autonomous driving maneuver user interface is displayed on the first display;
the method further comprises providing for display, on the second display, a graphical indicator of proximate objects of the one or more sensed objects in a direction of the current step of the autonomous maneuver.

9. The vehicle of claim 1, wherein:
prior to receiving the input indicating the selected position of the available positions of the vehicle, the autonomous driving maneuver user interface further includes graphical indicators of the available positions of the vehicle, and
the input indicating the selected position of the available positions of the vehicle includes a selection of an affordance associated with one of the graphical indicators of the available positions of the vehicle.

10. The vehicle of claim 1, further comprising:
a brake pedal, wherein the method further comprises:
while performing the autonomous driving maneuver, receiving input indicating a depression of the brake pedal, and
in response to the input indicating the depression of the brake pedal:
providing instructions to cease the autonomous driving maneuver, and
providing for display a graphical indicator indicating that the autonomous driving maneuver has ceased.

11. The vehicle of claim 1, the method further comprises, when the autonomous driving maneuver is complete, providing for display a graphical indicator indicating that autonomous maneuver is complete.

12. A non-transitory computer-readable medium including instructions, which when executed by one or more processors, cause the one or more processors to perform a method comprising:
determining available positions of a vehicle based on sensor data received from one or more sensors;
receiving input indicating a selected position of the available positions of the vehicle;
providing instructions to autonomously maneuver the vehicle to the selected position based on the sensor data and the selected position, the autonomous maneuver including one or more steps; and
providing for display an autonomous driving maneuver user interface including a graphical indicator of a current step of the autonomous maneuver and a graphical indicator of a destination position of the current step.

13. The non-transitory computer-readable storage medium of claim 12, wherein the autonomous maneuver is one of parking the vehicle or unparking the vehicle.

14. The non-transitory computer-readable storage medium of claim 12, wherein:
the sensor data includes data associated with one or more objects within a sensing range of the vehicle, and
the autonomous driving maneuver user interface further includes graphical indicators of at least one of the one or more sensed objects.

15. The non-transitory computer-readable storage medium of claim 12, wherein:
prior to receiving the input indicating the selected position of the available positions of the vehicle, the autonomous driving maneuver user interface further includes graphical indicators of the available positions of the vehicle, and
the input indicating the selected position of the available positions of the vehicle includes a selection of an affordance associated with one of the graphical indicators of the available positions of the vehicle.

16. A method comprising:
determining available positions of a vehicle based on sensor data received from one or more sensors of the vehicle;
receiving input indicating a selected position of the available positions of the vehicle;
providing instructions to autonomously maneuver the vehicle to the selected position based on the sensor data and the selected position, the autonomous maneuver including one or more steps; and
providing for display an autonomous driving maneuver user interface including a graphical indicator of a current step of the autonomous maneuver and a graphical indicator of a destination position of the current step.

17. The method of claim 16, wherein the autonomous maneuver is one of parking the vehicle or unparking the vehicle.

18. The method of claim 16, wherein:
the sensor data includes data associated with one or more objects within a sensing range of the vehicle, and
the autonomous driving maneuver user interface further includes graphical indicators of at least one of the one or more sensed objects.

19. The method of claim 16, wherein:
prior to receiving the input indicating the selected position of the available positions of the vehicle, the autonomous driving maneuver user interface further includes graphical indicators of the available positions of the vehicle, and
the input indicating the selected position of the available positions of the vehicle includes a selection of an affordance associated with one of the graphical indicators of the available positions of the vehicle.

20. A vehicle comprising:
means for determining available positions of the vehicle based on sensor data received from one or more sensors of the vehicle;
means for receiving input indicating a selected position of the available positions of the vehicle;
means for providing instructions to autonomously maneuver the vehicle to the selected position based on the sensor data and the selected position, the autonomous maneuver including one or more steps; and
means for providing for display an autonomous driving maneuver user interface including a graphical indicator of a current step of the autonomous maneuver and a graphical indicator of a destination position of the current step.
